(19) United States
(12) Patent Application Publication
(10) Pub. No.: US 2022/0365737 A1
(43) Pub. Date: Nov. 17, 2022

(54) System And Method For Mirroring A Remote Device

(71) Applicant: Silicon Laboratories Inc., Austin, TX (US)

(72) Inventor: Tamás Hornos, Budapest (HU)

(21) Appl. No.: 17/319,498

(22) Filed: May 13, 2021

(51) Int. Cl. G06F 3/147; G06F 3/0481; G06F 3/0484

(52) U.S. Cl. CPC G06F 3/147; G06F 3/0481; G06F 3/0484

(57) ABSTRACT

A system and method for mirroring and controlling a remote device is disclosed. The system includes a computer, executing a software program. The software program creates a graphic representation of the device on the screen, complete with the user interface, which may include LCD displays, LEDs, push buttons and reset buttons. The user can manipulate any of the buttons disposed on the device by manipulating the pointing device on the computer, and clicking on the button. Further, the software program displays the state of the output devices, such that the user can observe the state of the LEDs and the LCD display without being near the device. By mirroring the device on the computer screen, the user is able to share the information with others, such as via video calls.

This disclosure describes systems and methods allowing a computer to display and control the user interface of a remote device, and more particularly the user interface of a development kit.

### BACKGROUND

The explosion of network connected devices has led to an increased use of certain wireless protocols. For example, simple wireless network devices are being implemented as temperature sensors, humidity sensors, pressure sensors, motion sensors, cameras, light sensors, dimmers, light sources, and other functions. Additionally, these wireless network devices have become smaller and smaller.

As these network devices become smaller and simultaneously more complex, the issues associated with debugging them becomes problematic. For example, in certain embodiments, these network devices may be located remotely from the developer. Further, in other embodiments, development may be performed using a development kit, which is a network device that includes additional features, such as a user interface including, for example, an LCD screen, to enable the developer to better understand and control the operation of the network device. In certain situations, it may be advantageous to share the user interface with other individuals, such as other developers in order to share information about the code being executed by the development kit.

Yet, it is difficult to perform these operations, unless one uses a camera directed at the development kit. However, this is cumbersome and requires additional hardware.

Therefore, it would be advantageous if there were a system and method to allow a user to remotely view and control the user interface of a device. Further, it would be beneficial if this user interface could be shared by the user, such as during video conferences.

### SUMMARY

A system and method for mirroring and controlling a remote device is disclosed. The system includes a computer, executing a software program. The software program creates a graphic representation of the device on the screen, complete with the user interface, which may include LCD displays, LEDs, push buttons, keypads, joysticks, touchscreens, knobs and reset buttons. The user can manipulate any of the buttons disposed on the device by manipulating the pointing device of the computer, and actuating the button on the pointing device. Further, the software program displays the state of the output devices, such that the user can observe the state of the LEDs and the LCD display without being near the device. By mirroring the device on the computer screen, the user is able to share the information with others, such as via video calls.

According to one embodiment, a method for mirroring a remote device is disclosed. The method comprises creating a graphic representation of a user interface of the remote device on a display unit of a computer; accessing data within a processing unit of the remote device, where the data is associated with the user interface, wherein the data can be read and transmitted to the computer over a network connection without disrupting the operation of the processing unit; and updating the graphic representation to include the data transmitted to the computer. In some embodiments, the data is located in registers and memory locations within the processing unit. In certain embodiments, software to be executed by the remote device is compiled by the computer, and wherein the computer adds an additional code segment to the software, wherein the additional code segment, when executed by the processing unit, identifies addresses of registers and memory locations in the processing unit associated with the user interface, and saves the addresses in a region of memory. In certain embodiments, the region of memory is identified by a magic number that is created by the additional code segment. In some embodiments, addresses of the registers and memory locations in the processing unit associated with the user interface are provided to the computer. In certain embodiments, the graphic representation comprises a physical layout of the remote device wherein the user interface is located as it appears on the remote device. In some embodiments, the user interface of the remote device comprises an input device and wherein after pressing or releasing a button associated with a pointing device that is positioned on a graphic element that represents the input device in the graphic representation, a command is transmitted from the computer to the remote device to actuate the input device. In certain embodiments, the user interface comprises an LCD screen and where the computer saves an image of the LCD screen in a graphics file.

According to another embodiment, a system for mirroring and sharing is disclosed. The system comprises a computer having a display unit and a remote device, comprising a processing unit, a memory and a user interface; wherein the computer creates a graphic representation of the user interface of the remote device on the display unit, accesses data within the processing unit and displays the data on a graphic representation. In some embodiments, the data is located in registers and memory locations within the processing unit. In certain embodiments, software to be executed by the remote device is compiled by the computer, and wherein the computer adds an additional code segment to the software, wherein the additional code segment, when executed by the processing unit, identifies addresses of registers and memory locations in the processing unit associated with the user interface, and saves the addresses in a region of memory. In certain embodiments, the region of memory is identified by a magic number that is created by the additional code segment. In some embodiments, addresses of the registers and memory locations in the processing unit associated with the user interface are provided to the computer. In certain embodiments, the graphic representation comprises a physical layout of the remote device wherein the user interface is located as it appears on the remote device. In some embodiments, the user interface of the remote device comprises an input device and wherein after pressing or releasing a button associated with a pointing device that is positioned on a graphic element that represents the input device in the graphic representation, a command is transmitted from the computer to the remote device to actuate the input device. In certain embodiments, the user interface comprises an LCD screen and where the computer saves an image of the LCD screen in a graphics file.

According to another embodiment, a computer program, disposed on a non-transitory storage medium, is disclosed. The computer program, when executed by a computer, enables the computer to create a graphic representation of a user interface of a remote device on a display unit of the computer; access data within a processing unit of the remote device, where the data is associated with the user interface, wherein the data can be read and transmitted to the computer over a network connection without disrupting the operation of the processing unit; and update the graphic representation to include the data transmitted to the computer. In certain embodiments, the graphic representation comprises a physical layout of the remote device wherein the user interface is located as it appears on the remote device. In some embodiments, the user interface of the remote device comprises an input device and wherein after pressing or releasing a button associated with a pointing device that is positioned on a graphic element that represents the input device in the graphic representation, a command is transmitted from the computer to the remote device to actuate the input device. In certain embodiments, the user interface comprises an LCD screen and where the computer saves an image of the LCD screen in a graphics file.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of the device;

FIG. 2 is a block diagram of a system having a computer and one or more devices;

FIG. 3 shows the hardware and software architecture of the computer and device according to one embodiment;

FIG. 4 shows a graphic representation of the device according to one embodiment; and

FIG. 5 shows a graphic representation of the device according to a second embodiment.

### DETAILED DESCRIPTION

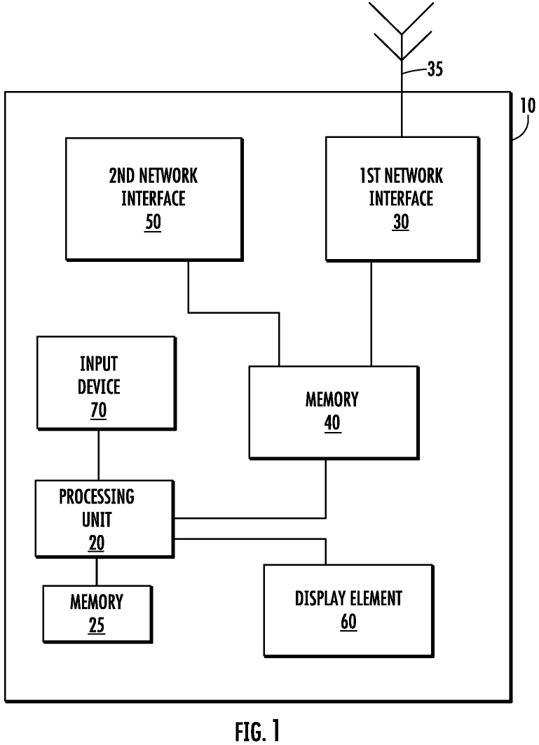

FIG. 1 shows a block diagram of a representative device 10. The device 10 has a processing unit 20 and an associated memory device 25. This memory device 25 contains the instructions, which, when executed by the processing unit 20, enable the device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM. In certain embodiments, the memory device 25 may be packaged with the processing unit 20. The processing unit 20 may be any suitable device, including but not limited to a general purpose processor, an application specific processor, an embedded controller, or a personal computer (PC).

In certain embodiments, the processing unit 20 may be an ARM® Cortex® processor. The ARM® Cortex® processor has a Debug Access Port that allows access to various debug capabilities. These capabilities include the ability to set breakpoints, the ability to set watchpoints, the ability to read memory locations, the ability to read register locations and others. This Debug Access Port allows external debugger hardware to attach to the ARM® Cortex® processor.

The device 10 may also include a first network interface 30, which is typically a wireless interface including an antenna 35. The first network interface 30 may support any wireless network, including ZIGBEE®, thread, Z-Wave, BLUETOOTH® or other protocols. In certain embodiments, the device 10 may include a second network interface 50, different from the first network interface 30. This second network interface 50 may support any desired network protocol, such as WiFi, Ethernet or USB. This second network interface 50 may be used in conjunction with the Debug Access Port to perform the functions described herein.

The device 10 may include a second memory device 40 in which data that is received by the first network interface 30, and data that is to be transmitted by the first network interface 30, is stored. Additionally, data sent and received by the second network interface 50 may be stored in the second memory device 40. This second memory device 40 is traditionally a volatile memory. The processing unit 20 has the ability to read and write the second memory device 40 so as to communicate with the other devices in the network. Although not shown, the device 10 also has a power supply, which may be a battery or a connection to a permanent power source, such as a wall outlet.

In certain embodiments, the device 10 does not include the first network interface 30.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device. The instructions contained on this second computer readable media may be downloaded onto the memory device 25 to allow execution of the instructions by the device 10.

In certain embodiments, the device 10 may be a development kit, which is used by developers to design new products. As such, the device 10 may have functionality that is not typically included in a production device.

For example, the device 10 may also include a user interface that includes a display element 60 and/or an input device. In some embodiments, the display element 60 may be one or more LEDs and/or LCD screens. In certain embodiments, the display element 60 is a touch screen so that input may be supplied to the processing unit 20 through the display element 60. In other embodiments, the device 10 may also be in communication with a separate input device 70 to allow user entry. The input device may be one or more push buttons, for example. Alternatively, or additionally, the input device may include a joystick, keypad, knob, or other device. In other words, the display element 60 and the input device 70 are not limited to those enumerated above.

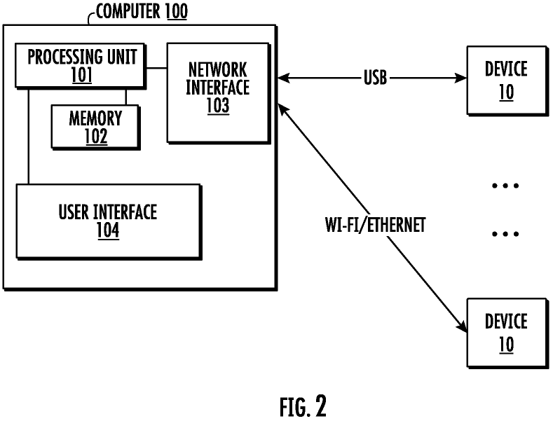

FIG. 2 shows a block diagram of a representative configuration comprising a computer 100 and one or more devices 10. The computer 100 may be a standard desktop or laptop computer, or may be another computing device.

The computer 100 is used to communicate with the device 10. The computer 100 comprises a processing unit 101 with an associated memory 102. The memory 102 may be a volatile memory, such as DRAM, or may be non-volatile, such as FLASH memory, magnetic storage or optical storage. The memory 102 contains instructions and programs, which when executed by the processing unit 101, enable the computer 100 to perform the functions described herein. In other words, the computer includes a software program, disposed on a computer readable non-transitory storage medium, that enables the computer to perform the actions described herein. The computer 100 also comprises a network interface 103, which utilizes the same protocol as the second network interface 50 of the device 10, such as Ethernet, WiFi or USB. The computer 100 also comprises a user interface 104. The user interface 104 may include a display unit, such as an LCD screen or a touchscreen, a keyboard, a mouse or other pointing device, or a combination of these components. The computer 100 can be any suitable personal computer with a network interface and a user interface. Additionally, the computer 100 may be a mobile computing device, such as a laptop computer, tablet, smart phone or other device.

As shown in FIG. 2, the connection between the computer 100 and the device 10 may be a wired connection, such as Ethernet or USB. In other embodiments, this connection may be wireless, such as WiFi.

As noted above, the device 10 may comprise a user interface, that comprises a display element 60 and an input device 70. There are situations where access to the user interface may be limited, such as in the case of remote development or collaboration. Additionally, there may be situations when sharing the user interface with a remote user may be desirable. However, providing remote access to the user interface is not trivial.

The present disclosure describes a system and method to overcome this problem.

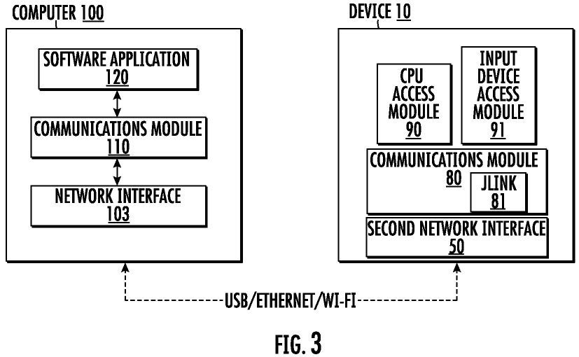

FIG. 3 shows the hardware and software used by the computer 100 and the device 10 to implement the functions described herein. The computer 100 comprises a software module, referred to as the communications module 110. The communications module 110 comprises the software that enables the computer 100 to communicate with the devices 10 using USB, Ethernet, WiFi or another protocol. In certain embodiments, the communications module 110 is able to directly modify hardware registers within the WiFi or USB controller disposed in the network interface 103 so as to transmit and receive data from the device 10. In certain embodiments, the communications module 110 is used to read and write registers and memory locations disposed on the device 10.

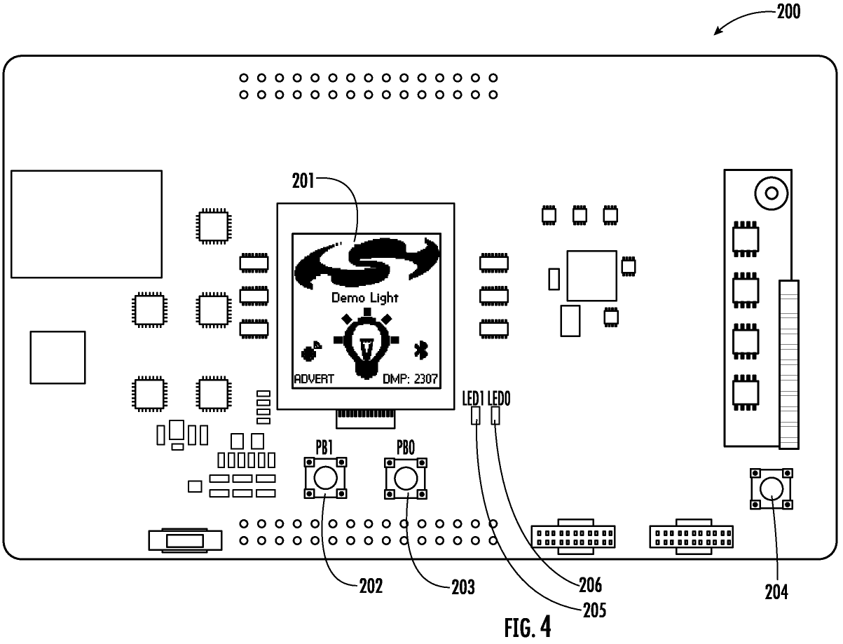

The computer 100 also includes a software application 120 which controls what data is accessed and displayed from the device 10. The software application 120 may include, for example, a GUI (graphic user interface) module, which allows the computer to display a representation of the user interface of the device 10 on the user interface 104 of the computer 100. The user interface of the device 10 may include the display element 60 and the input device 70. In certain embodiments, the GUI module allows different representations of the device to be displayed on the user interface 104. For example, as shown in FIG. 4, the GUI module may display a graphic representation 200 of the device 10 that shows the physical layout of the device 10. This graphic representation 200 includes graphic elements that represent the display element 60, which may comprise an LCD display 201 and LEDs 205, 206 and the input device 70, which may comprise push buttons 202, 203, and a reset button 204. These graphic elements may be positioned in the graphic representation as they appear on the actual device 10.

Additionally, the GUI module also allows the user to control the device 10. For example, the user, by moving a cursor of a pointing device to a graphic element that represents a push button in the graphic representation 200 and then pressing the button of the pointing device, may be able to remotely actuate the push buttons 202, 203 on the device 10. The results of this action are then displayed on an updated graphic representation 200 of the device 10. In certain embodiments, the pressing of the button and the release of the button may be considered two separate events, such that push button 202 may be actuated for as long as the button of the pointing device is pressed. In this way, the user may remotely actuate the push buttons 202, 203 for an arbitrary amount of time.

The software application 120 may be written in any suitable language, such as, but not limited to, Python.

The combination of the software application 120 and the communications module 110 may comprise the software program that is executed by the computer 100.

The architecture within the device 10 comprises a software module, referred to as the communications module 80. This communications module 80 may be in communication with the second network interface 50. This communications module 80 allows communication with the computer 100 by directly modifying registers within the second network interface 50.

The device may also comprise a CPU Access Module 90 and an Input Device Access module 91. The CPU Access Module 90 is able to directly access memory and registers within the processing unit 20. Additionally, the Input Device Access module 91 is able to actuate the input devices on the device 10.

For example, in certain embodiments, the processing unit 20 of the device 10 may be an ARM® Cortex® processor. As described above, the ARM® Cortex® processor has a Debug Access Port that allows access to various debug capabilities. These capabilities include the ability to read memory locations, the ability to read and write register locations and others. This Debug Access Port allows external debugger hardware to attach to the ARM® Cortex® processor. Importantly, the act of accessing memory locations and registers within the processing unit 20 does not affect the operation of the processing unit 20. In other words, no special software is executed by the processing unit to access these locations. The present disclosure takes advantage of these built-in features of the processor.

While the ARM® Cortex®-M4 processor is specifically described above, any processing unit having this functionality may be employed in the present system.

In certain embodiments, the communications module 80 may comprise a hardware component. For example, in certain embodiments, a Segger JLINK module 81 may be incorporated into the device 10 to allow access to the memory and registers of the processing unit 20 via the Debug Access Port. This Segger JLINK module 81 comprises hardware components and software components that enable remote access to the processing unit 20. However, in other embodiments, other hardware and/or software may be employed. For example, a custom hardware module may be used to perform this function or to monitor the SPI bus, and the GPIO pins of the processing unit 20.

Note that in the embodiment wherein a Segger JLINK module 81 is employed, the communications module 110 of the computer 100 may be a corresponding DLL (Dynamic Link Library) that is also provided by Segger. However, the disclosure is not limited to this embodiment.

FIG. 4 shows a graphic representation 200 of the device 10 that may be displayed on the user interface 104 of the computer. In one embodiment, the GUI module of the software application 120 may include a bit map or other structure that represents the physical appearance of the device 10. In certain embodiments, the software application 120 may first establish network communications with the device 10 so as to determine its configuration and appearance. In this embodiment, the software application 120 may store a plurality of bit maps or other structure, each of which is associated with a corresponding supported device 10. Thus, the computer 100 may contain graphical libraries that contain the graphical representations of the devices 10 that are supported by the software application 120.

In this graphic representation 200, the state of the display elements 60 of the device 10 is shown on the user interface 104 of the computer. For example, in FIG. 4, graphic elements that represent the display elements 60 comprise an LCD display 201 and a plurality of LEDs 205, 206. The state of the LCD display 201 is determined by reading the values of the memory locations within the device 10 that correspond to the LCD display. For example, within the memory of the device 10, there may be a structure, which may be a bit map or other structure, that comprises the image that is displayed on the LCD display. The CPU Access Module 90 may access these memory locations to retrieve the requested bit map or other structure. The bit map or other structure is then transmitted to the computer 100 via the communications module 80. This information is then displayed in the area of the graphic representation 300 that corresponds to the LCD display 201.

Similarly, there may be memory or register locations that correspond to the LEDs 205, 206 on the device 10. The CPU Access Module 90 may read the current state of these memory and/or register locations. This information is then transmitted to the computer 100. The software application 120 may then illuminate or deactivate the portion of the graphic representation 200 that corresponds to each LED.

In this way, the computer 100 may acquire the state of all display elements 60 of the device 10. As noted above, accessing the registers and memory locations of the processing unit 20 does not affect the operation of the device 10, since no special software is executed by the processing unit 20 to allow this feature. The GUI module then updates the graphic representation 200 with the new data. In certain embodiments, the computer 100 may update the graphic representation 200 at regular intervals. For example, if the LCD display 201 includes a video, animation, motion picture or other similar feature, the computer 100 may update the graphic representation 200 at a fixed rate, such as twenty four times per second.

Thus, in one embodiment, the computer 100 requests that the contents of a particular set of memory locations be transmitted from the device 10, via the second network interface 50 to the network interface 103 of the computer 100. The software application 120, and more specifically, the GUI module, then displays the acquired data in the graphic representation 200 of the device 10, which is displayed on the user interface 104 of the computer 100.

Similarly, the user may wish to remotely actuate an input device 70 of the device 10, such as push buttons 202, 203. In this case, there are mechanisms in the device 10 that allow the state of the input devices 70 to be changed. For example, the user may click on the graphic element that represents push button 202 on the graphic representation 200. This action is recognized by the software application 120 as an indication that the state of the push button 202 is to be changed. The communications module 110 then transmits the command to the Input Device Access Module 91. The Input Device Access Module 91 then executes the command to actuate the selected input device. This action causes the same action as if the push button 202 on the device 10 had been physically pressed. For example, in one embodiment, there may be physical switches disposed in the remote device 10 that are controlled by the Input Device Access Module 91, such that actuating these switches has the same effect as actuating the push button 202.

In another embodiment, these physical switches may be controlled by the processing unit, such as via an output register. In this embodiment, a write to the appropriate register in the processing unit 20 may cause the physical switch to be actuated.

In other words, there are a plurality of ways in which a push button may be remotely actuated. In all embodiments, the input device 70 may be actuated by moving the pointing device of the computer 100 so that the cursor is on the graphic element in the graphic representation 300 that represents the input device 70. The button on the pointing device is then pressed and released.

In certain embodiments, the memory locations within the device 10 that correspond to the display element 60 and input device 70 of the device 10 are not fixed. In other words, each time that code is compiled for the device 10, the memory location associated with these elements may change.

Thus, to properly execute, the software application 120 must have a mechanism to identify where each of these memory locations is located. This may be done in a number of ways.

In one embodiment, the user may manually enter the memory locations associated with each display and input device. This may be performed by reviewing the map file of the firmware that is contained within the device 10. Further, the user may review the register addresses of the push buttons and LEDs from the code and the pin numbers. Once the addresses are determined, the user may then supply these addresses to the software application 120. For example, a command line command may be implemented which allows the user to specify a component (i.e., the LCD display, the LEDs, the push buttons, the reset button, etc.) and provide the address associated with that component. For example, a sample instruction may be

Mirror -lcd 0xabbaedda -led1 0xa84bcd90 -led2 0xcb4408cc -button1 0xa042313de

where “mirror” is the name of the software application, -lcd indicates that the next parameter is the memory address of the LCD display, -led1 indicates that the next parameter is the memory address of the LED 205, -led2 indicates that the next parameter is the memory address of the LED 206 and -buttonl indicates that the next parameter is the memory address of the push button 202.

In this embodiment, the code that is to be executed by the device 10 is not modified or changed, and can still be mirrored and controlled by the computer 100. There may be use cases where running the unmodified production FW is desired or it is not an option to modify it, and yet the device may still be mirrored to the user interface 104 of the computer 100.

In a second embodiment, the software application 120 on the computer 100 may parse the map file and automatically determine the locations of each display and input device. For example, if the variable names in question are known, the memory addresses associated with these variable names can be determined by studying the LCD software module, the button handler and the LED software modules.

According to a third embodiment, the user may add an additional code segment to the firmware that is compiled and loaded into the device 10. This additional code segment may be rather small in size and may execute during initialization time. During its execution, the additional code segment identifies the memory addresses of interest. It then saves all of these memory addresses in a region of memory where the computer 100 may access them. In certain embodiments, the location of this region may not be fixed. Thus, to allow the computer 100 to identify this region, the additional code segment may write a unique string, also referred to as a magic number, at the beginning of the region. This unique string is intended to be a series of values which does not appear elsewhere in the memory of the device 10. In this way, the software application may begin by retrieving the entirety of the memory in the device 10, until it encounters the unique string. Once the unique string is located, the software application can then read the associated region of memory, which contains one or more of the following:

the memory address that corresponds to the start of the bit map for the LCD display;

the register or memory addresses that correspond to the one or more LEDs; and

the registers or memory addresses that correspond to the state of the one or more push buttons or switches.

Once these addresses are found, the software program may mirror the display elements and control the input devices as described above.

Of course, the magic number may appear at the end of the region. In other words, in either embodiment, the magic number is used to identify the location of the region that contains the addresses of the locations associated with the user interface.

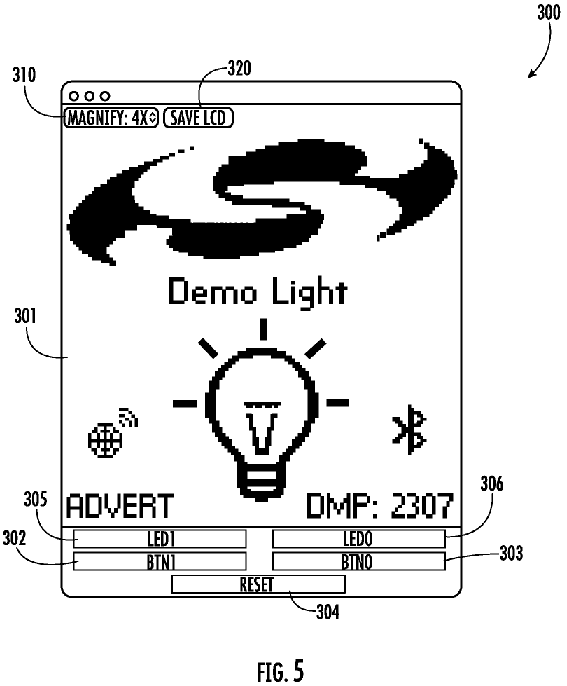

In another embodiment, the software application 120 may display a graphic representation 300 that only includes the input devices and display elements. Such a graphic representation 300 is shown in FIG. 5. In this graphic representation 300, the LCD screen 301, which was shown in FIG. 4, is still visible. Further, the LEDs 305, 306 are also present. Additionally, the push buttons 302, 303 are also present. Lastly, the reset button 304 may also be present. This graphic representation 300 may be used in the same manner as the graphic representation 200 described above; however, it does not reflect the physical appearance of the device 10.

The graphic representation 300 may provide additional functionality. For example, this graphic representation 300 includes an icon 310 that allows the user to magnify the size of the graphic representation 300. For example, the graphic representation may be magnified 2, 4 or 8 times, for example.

Additionally, this graphic representation 300 includes a second icon 320 that allows the user to save the image on the LCD screen 301 in a graphics file. The file format is not limited by this disclosure, and may be portable network graphics (png) format, joint photographic experts group(jpg) format, or another suitable format.

Thus, in one embodiment, a method of mirroring and optionally controlling a remote device is disclosed. The method includes creating a graphic representation of a user interface of the remote device on a display unit of a computer; accessing data within a processing unit of the remote device, wherein the data is associated with the user interface, and can be read and transmitted to the computer over a network connection without disrupting the operation of the processing unit; and updating the graphic representation to include the data transmitted to the computer.

In another embodiment, a system for mirroring is disclosed. The system comprises a computer having a user interface; and a remote device, comprising a processing unit, a memory and a user interface; wherein the computer creates a graphic representation of the remote device on the user interface, accesses data within the processing unit and displays the data on the graphic representation.

In another embodiment, a software program, which is executed by a computer is disclosed. The software program is stored on a non-transitory computer readable medium. When executed by a computer, the software program enables the computer to create a graphic representation of a user interface of a remote device on a display unit of the computer; access data within a processing unit of the remote device, where the data is associated with the user interface, wherein the data can be read and transmitted to the computer over a network connection without disrupting the operation of the processing unit; and update the graphic representation to include the data transmitted to the computer.

This system and method have many advantages.

First, this system and method allows the developer to remotely debug and test the device without having to be physically nearby to see and control the user interface. This allows the developer to observe the operation of the device remotely.

Second, this system allows collaboration. By having the ability to display the user interface of the device on a computer screen, that screen can then be shared with others, such as during video calls.

Third, the ability to save the LCD screen image to a file allows the creation of documentation that is pixel perfect. Currently, documentation is created by taking photographs of the LCD screen, which leads to shadows, shading and offsets. These issues are all overcome by using the saved files.

Fourth, the ability to mirror the user interface of the device allows for internal and external training courses. It also allows for customer demonstrations and workshops.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method for mirroring a remote device, comprising:
creating a graphic representation of a user interface of the remote device on a display unit of a computer, wherein the graphic representation comprises a physical layout of the remote device wherein the user interface is located as it appears on the remote device;
accessing data within a processing unit of the remote device via a Debug Access Port, where the data is associated with the user interface, wherein the data can be read and transmitted to the computer over a network connection without disrupting operation of the processing unit such that no software is executed by the processing unit to access the data; and
updating the graphic representation to include the data transmitted to the computer.

2. The method of claim 1, wherein the data is located in registers and memory locations within the processing unit.

3. The method of claim 2, wherein software to be executed by the remote device is compiled by the computer, and wherein the computer adds an additional code segment to the software, wherein the additional code segment, when executed by the processing unit, identifies addresses of registers and memory locations in the processing unit associated with the user interface, and saves the addresses in a region of memory.

4. The method of claim 3, wherein the region of memory is identified by a magic number that is created by the additional code segment.

5. The method of claim 2, wherein addresses of the registers and memory locations in the processing unit associated with the user interface are provided to the computer.

6. (canceled)

7. The method of claim 1, wherein the user interface of the remote device comprises an input device and wherein after pressing or releasing a button associated with a pointing device that is positioned on a graphic element that represents the input device in the graphic representation, a command is transmitted from the computer to the remote device to actuate the input device.

8. The method of claim 1, wherein the user interface comprises an LCD screen and where the computer saves an image of the LCD screen in a graphics file.

9. A system for mirroring and sharing, comprising:
a computer having a display unit; and
a remote device, comprising a processing unit having a Debug Access Port, a memory and a user interface;
wherein the computer creates a graphic representation of the user interface of the remote device on the display unit, wherein the graphic representation comprises a physical layout of the remote device wherein the user interface is located as it appears on the remote device; accesses data within the processing unit via the Debug Access Port such that no software is executed by the processing unit to access the data and displays the data on the graphic representation.

10. The system of claim 9, wherein the data is located in registers and memory locations within the processing unit.

11. The system of claim 10, wherein software to be executed by the remote device is compiled by the computer, and wherein the computer adds an additional code segment to the software, wherein the additional code segment, when executed by the processing unit, identifies addresses of the registers and memory locations in the processing unit, and saves the addresses in a region of memory.

12. The system of claim 11, wherein the region of memory is identified by a magic number that is created by the additional code segment.

13. The system of claim 10, wherein addresses of the registers and memory locations are provided to the computer.

14. (canceled)

15. The system of claim 9, wherein the user interface of the remote device comprises an input device and wherein after pressing or releasing a button associated with a pointing device that is positioned on a graphic element that represents the input device in the graphic representation, a command is transmitted from the computer to the remote device to actuate the input device.

16. The system of claim 9, wherein the user interface comprises an LCD screen and where the computer saves an image of the LCD screen in a graphics file.

17. A computer program, disposed on a non-transitory storage medium, which when executed by a computer, enables the computer to:
create a graphic representation of a user interface of a remote device on a display unit of the computer, wherein the graphic representation comprises a physical layout of the remote device wherein the user interface is located as it appears on the remote device;
access data within a processing unit of the remote device via a Debug Access Port, where the data is associated with the user interface, wherein the data can be read and transmitted to the computer over a network connection without disrupting operation of the processing unit such that no software is executed by the processing unit to access the data; and
update the graphic representation to include the data transmitted to the computer.

18. (canceled)

19. The computer program of claim 17, wherein the user interface of the remote device comprises an input device and wherein after pressing or releasing a button associated with a pointing device that is positioned on a graphic element that represents the input device in the graphic representation, the computer program transmits a command from the computer to the remote device to actuate the input device.

20. The computer program of claim 17, wherein the user interface comprises an LCD screen and where the computer program saves an image of the LCD screen in a graphics file.
